(19) United States
(12) Patent Application Publication
(10) Pub. No.: US 2025/0276749 A1
(43) Pub. Date: Sep. 4, 2025

(54) MOBILE ROBOT AND CONTROL METHOD THEREFOR

(71) Applicant: Tencent Technology (Shenzhen) Company Limited, Shenzhen (CN)

(72) Inventors: Xiong LI, Shenzhen (CN); Shuai WANG, Shenzhen (CN); Dongsheng ZHANG, Shenzhen (CN); Haitao WANG, Shenzhen (CN); Qinqin ZHOU, Shenzhen (CN); Lingzhu XIANG, Shenzhen (CN); Jingchen LI, Shenzhen (CN); Yu ZHENG, Shenzhen (CN); Wanchao CHI, Shenzhen (CN); Yufeng ZHANG, Shenzhen (CN); Ke CHEN, Shenzhen (CN); Zhengyou ZHANG, Shenzhen (CN)

(73) Assignee: Tencent Technology (Shenzhen) Company Limited, Shenzhen (CN)

(21) Appl. No.: 19/210,062

(22) Filed: May 16, 2025

Related U.S. Application Data
(63) Continuation of application No. PCT/CN2023/131429, filed on Nov. 14, 2023.

(30) Foreign Application Priority Data
Apr. 25, 2023 (CN) 202310468765.7

(51) Int. Cl. B62D 57/032; B62D 57/02

(52) U.S. Cl. CPC B62D 57/032; B62D 57/022

(57) ABSTRACT

A mobile robot includes at least three swing legs distributed side by side that are grouped into a first swing leg group and a second swing leg group, and at least one from among the first swing leg group and the second swing leg group include at least two swing legs respectively located on two sides of a center of gravity of the mobile robot.

### CROSS-REFERENCE TO RELATED APPLICATIONS

This application is a continuation application of International Application No. PCT/CN2023/131429 filed on Nov. 14, 2023, which claims priority to Chinese Patent Application No. 202310468765.7 filed with the China National Intellectual Property Administration on Apr. 25, 2023, the disclosures of each being incorporated by reference herein in their entireties.

### FIELD

The disclosure relates to the field of robots, and in particular, to a mobile robot and a method for controlling a mobile robot.

### BACKGROUND

Biped humanoid robots have difficulty maintaining stability statically. Biped humanoid robots may have defects in that, regardless of whether the robot is powered on or off, a position of a center of gravity may need to be dynamically adjusted to balance the robot.

### SUMMARY

According to an aspect of the disclosure, a mobile robot includes at least three swing legs distributed side by side.

The at least three swing legs may be grouped into a first swing leg group and a second swing leg group, and at least one from among the first swing leg group and the second swing leg group may include at least two swing legs respectively located on two sides of a center of gravity of the mobile robot.

According to an aspect of the disclosure, a method for controlling a mobile robot including at least three swing legs that are distributed side by side, includes controlling the at least three swing legs to execute a leg action on a reference plane.

A first swing leg group of the mobile robot may include a plurality of first swing legs, and at least two of the plurality of first swing legs may be respectively located on two sides of a center of gravity of the mobile robot. A second swing leg group of the mobile robot may include one second swing leg, and the one second swing leg may be located on a central axis of the mobile robot. The controlling the at least three swing legs may include controlling the first swing leg group and the second swing leg group to stand crosswise, the first swing leg group being located before the second swing leg group; controlling, by using the first swing leg group as a first support leg, the second swing leg group to rotate to a first foot falling point; and controlling, by using the second swing leg group as a second support leg, the first swing leg group to rotate to a second foot falling point.

According to an aspect of the disclosure, a non-transitory computer-readable storage medium, storing computer code which, when executed by at least one processor, causes the at least one processor to at least control at least three swing legs of a mobile robot to execute a leg action on a reference plane, wherein the at least three swing legs are distributed side by side. The controlling the at least three swing legs may include controlling a first swing leg group and a second swing leg group to stand crosswise, the first swing leg group being located before the second swing leg group; controlling, by using the first swing leg group as a first support leg, the second swing leg group to rotate to a first foot falling point; and controlling, by using the second swing leg group as a second support leg, the first swing leg group to rotate to a second foot falling point.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic structural diagram of a mobile robot according to some embodiments.

FIG. 2 is a schematic structural diagram of a mobile robot according to some embodiments.

FIG. 3 is a flowchart of a method for controlling a mobile robot according to some embodiments.

FIG. 4 is a schematic diagram of legs of a mobile robot standing close according to some embodiments.

FIG. 5 is a schematic diagram of folding of a mobile robot according to some embodiments.

FIG. 6 is a schematic diagram of a mobile robot executing a task according to some embodiments.

FIG. 7 is a flowchart of a method for controlling a mobile robot according to some embodiments.

FIG. 8 is a schematic diagram of a mobile robot spanning an obstacle according to some embodiments.

FIG. 9 is a schematic diagram of a mobile robot spanning an obstacle according to some embodiments.

FIG. 10 is a schematic diagram of a mobile robot ascending/descending a staircase according to some embodiments.

FIG. 11 is a schematic diagram of a method for controlling a mobile robot according to some embodiments.

FIG. 12 is a schematic diagram of an apparatus for controlling a mobile robot according to some embodiments.

FIG. 13 is a block diagram of a mobile robot according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

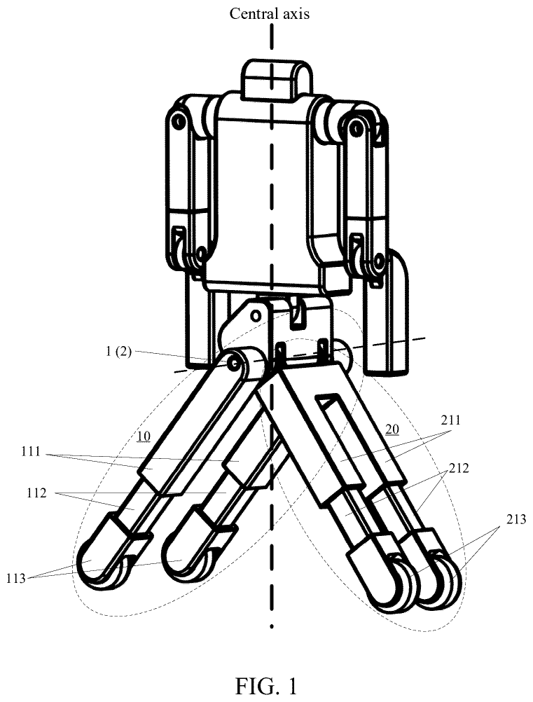

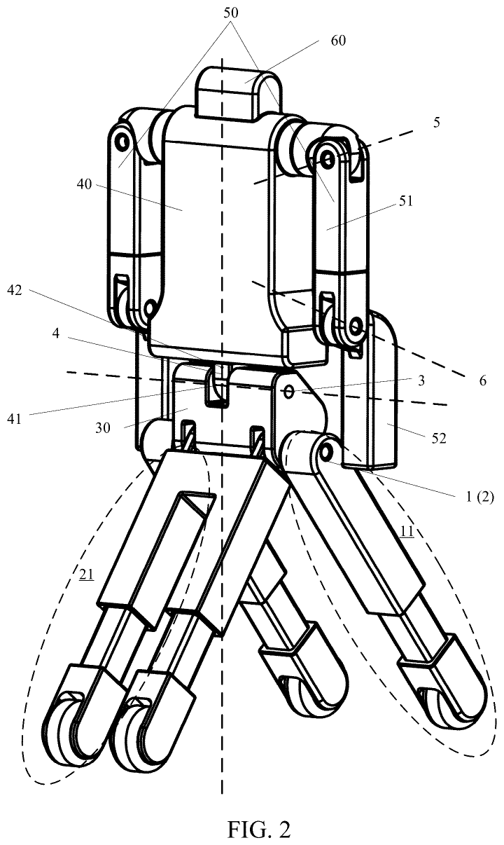

With reference to FIG. 1 and FIG. 2, it may be obtained through observation that a mobile robot provided in some embodiments includes at least three swing legs, the at least three swing legs being distributed side by side, and rotation shafts of the at least three swing legs being located on the same vertical plane. Distribution side by side refers to a state in which projections of the at least three swing legs of the mobile robot along a first direction do not overlap. The rotation shafts being located on the same vertical plane refers to a state in which projections of the at least three swing legs of the mobile robot along a second direction do not overlap. The first direction is a direction that a front surface or a back surface of the mobile robot faces. The second direction is a direction that a side surface of the mobile robot faces. In some embodiments, rotation shafts of at least two of the at least three swing legs are coaxial. In some embodiments, the rotation shafts of the at least three swing legs are uncoaxial.

In some embodiments, the at least three swing legs are grouped into a first swing leg group and a second swing leg group. At least one of the first swing leg group and the second swing leg group includes at least two swing legs, and the at least two swing legs are respectively located on two sides of a center of gravity of the mobile robot.

In some embodiments, the first swing leg group includes a plurality of first swing legs, the second swing leg group includes one second swing leg, at least two of the plurality of first swing legs are located on the two sides of the center of gravity of the mobile robot, and the second swing leg is located on a central axis of the mobile robot.

In some embodiments, the second swing leg group includes a plurality of second swing legs, the first swing leg group includes one first swing leg, at least two of the plurality of second swing legs are located on the two sides of the center of gravity of the mobile robot, and the first swing leg is located on a central axis of the mobile robot.

In some embodiments, the first swing leg group includes a plurality of first swing legs, the second swing leg group includes a plurality of second swing legs, and “a plurality” indicates two or more. At least two of the plurality of first swing legs are respectively located on the two sides of the center of gravity of the mobile robot. The second swing leg group includes a plurality of second swing legs, and at least two of the plurality of second swing legs are respectively located on the two sides of the center of gravity on a central axis of the mobile robot. The first swing leg group and the second swing leg group support travelling in a crossed gait.

With reference to FIG. 1 and FIG. 2, FIG. 1 and FIG. 2 show side views of a mobile robot according to some embodiments. The mobile robot includes a first swing leg group 10 and a second swing leg group 20. The first swing leg group 10 includes a plurality of first swing legs 11, the second swing leg group 20 includes a plurality of second swing legs 21, at least two of the plurality of first swing legs 11 are respectively located on two sides of a center of gravity of the mobile robot, and at least two of the plurality of second swing legs 21 are respectively located on the two sides of the center of gravity of the mobile robot. The plurality of first swing legs 11 and the plurality of second swing legs 21 are distributed side by side. When the foregoing distribution condition is met, further, in some embodiments, the plurality of first swing legs 11 and the plurality of second swing legs 21 are distributed in a staggered manner one by one. In some embodiments, the plurality of first swing legs 11 are distributed on two sides of the plurality of second swing legs 21.

Exemplarily, an example in which the first swing leg group 10 is a leg group A and the second swing leg group 20 is a leg group B is used, and cases in which the plurality of first swing legs 11 and the plurality of second swing legs 21 are distributed side by side may be A1, B1, B2, and A2 (a distribution case 1); A1, B1, A2, and B2 (a distribution case 2); A1, A2,B1, A3, B2, and B3 (a distribution case 3); A1, A2, B1, B2, B3, A3 (a distribution case 4), and the like. Similarly, more or less swing legs may be disposed in a similar manner of being distributed side by side.

With reference to FIG. 1 and FIG. 2, FIG. 1 and FIG. 2 show that the first swing leg group 10 includes two first swing legs (outer legs) 11, and that the second swing leg group 20 includes two second swing legs (inner legs) 21. The two first swing legs 11 are symmetrically distributed along a central axis of the mobile robot, and the two second swing legs 21 are symmetrically distributed along the central axis of the mobile robot. A distance between the first swing leg 11 and the central axis is greater than a distance between the second swing leg 21 and the central axis.

In a travelling process of the mobile robot, the first swing leg group 10 and the second swing leg group 20 support travelling in a crossed gait, that is, the first swing leg group 10 and the second swing leg group 20 alternately travel as front and rear leg groups, respectively. In an exemplary travelling process, the second swing leg group 20 swings to a first foot falling point by using the first swing leg group 10 as a support leg, and subsequently, the first swing leg group 10 swings to the second foot falling point by using the second swing leg group 20 as a support leg.

Specifically, in an initial posture, the plurality of first swing legs 11 are used as front legs to come into contact with the ground, and the plurality of second swing legs 21 are used as rear legs to come into contact with the ground. In this case, a projection of the center of gravity of the robot is located in a geometric figure formed by contact points of the front and rear legs and the ground. The plurality of first swing legs 11 are used as the support leg, the plurality of second swing legs 21 swing to the first foot falling point, and the center of gravity of the robot is controlled to move forward. When the plurality of second swing legs 21 swing to the first foot falling point, the center of gravity of the robot is controlled to be re-located in the geometric figure formed by the contact points between the front and rear legs and the ground. The plurality of second swing legs 21 are used as the support leg, the plurality of first swing legs 11 swing to the second foot falling point, and the center of gravity of the robot is controlled to move forward. When the plurality of second swing legs 21 swing to the first foot falling point, the center of gravity of the robot is controlled to be re-located in the geometric figure formed by the contact points between the front and rear legs and the ground.

When the swing leg of the robot swings, the swing leg is controlled to extend and shorten. Exemplarily, when a center of gravity of the swing leg is located behind the center of gravity of the mobile robot, the swing leg is controlled to shorten. When a center of gravity of the swing leg is located before the center of gravity of the mobile robot, the swing leg is controlled to extend.

According to the foregoing mobile robot, the first swing leg group and the second swing leg group are disposed, the first swing leg group includes the plurality of first swing legs, the second swing leg group includes the plurality of second swing legs, the at least two of the plurality of first swing legs are respectively located on the two sides of the center of gravity of the mobile robot, the at least two of the plurality of second swing legs are respectively located on the two sides of the center of gravity of the mobile robot, and the plurality of first swing legs and the plurality of second swing legs are distributed side by side, so that the mobile robot can be static and stable in a standing posture without dynamically adjusting a center-of-gravity position of the mobile robot. In addition, the foregoing mobile robot supports travelling in a crossed gait. In a travelling process, the mobile robot may not consider balance in a rolling direction, and the rolling direction is perpendicular to a travelling direction.

In some embodiments, the plurality of first swing legs 11 are rotatably connected to a first swing rotation shaft, and the first swing rotation shaft is perpendicular to the travelling direction of the mobile robot. In some embodiments, the first swing rotation shaft is located at a position such as a hip, a waist, or a head top of the mobile robot. In some embodiments, the plurality of second swing legs 21 are rotatably connected to a second swing rotation shaft, and the second swing rotation shaft is perpendicular to the travelling direction of the mobile robot. In some embodiments, the second swing rotation shaft is located at a position such as a hip, a waist, or a head top of the mobile robot.

In some embodiments, the first swing rotation shaft is located at the hip of the mobile robot. With reference to FIG. 2, in this case, the first swing rotation shaft is a first hip rotation shaft 1. When the mobile robot stands on a horizontal reference plane, the first hip rotation shaft 1 extends horizontally. The plurality of first swing legs 11 is rotatably connected to the first hip rotation shaft 1, and any two of the plurality of first swing legs 11 are parallel.

In some embodiments, the second swing rotation shaft is located at the hip of the mobile robot. With reference to FIG. 2, in this case, the second swing rotation shaft is a second hip rotation shaft 2. When the mobile robot stands on a horizontal reference plane, the second hip rotation shaft 2 extends horizontally. The plurality of second swing legs 21 is rotatably connected to the second hip rotation shaft 2, and any two of the plurality of second swing legs 21 are parallel.

In some embodiments, the first hip rotation shaft 1 and the second hip rotation shaft 2 are coaxial; and/or the first hip rotation shaft 1 and the second hip rotation shaft 2 are located on the same vertical plane. FIG. 1 and FIG. 2 show a case in which the first hip rotation shaft 1 and the second hip rotation shaft 2 are coaxial and located on the same vertical plane.

In some embodiments, the mobile robot further includes a first rotation motor and a second rotation motor. The first rotation motor is configured to drive the first swing leg group 10 to rotate about the first hip rotation shaft 1 in a linked manner. The second rotation motor is configured to drive the second swing leg group 20 to rotate about the second hip rotation shaft 2 in a linked manner.

In some embodiments, the mobile robot further includes a third rotation motor corresponding to the first swing leg 11 and a fourth rotation motor corresponding to the second swing leg 21. The third rotation motor is configured to drive the first swing leg 11 to rotate about the first hip rotation shaft 1. The fourth rotation motor is configured to drive the second swing leg 21 to rotate about the second hip rotation shaft 2. In some embodiments, a plurality of third rotation motors respectively corresponding to the plurality of first swing legs 11 support controlling the plurality of first swing legs 11 to rotate in a linked manner or independently. In some embodiments, a plurality of fourth rotation motors respectively corresponding to the plurality of second swing legs 21 support controlling the plurality of second swing legs 21 to rotate in a linked manner or independently.

With reference to FIG. 1 and FIG. 2, the first swing leg 11 includes a first mechanical thigh 111 and a first mechanical calf 112, and the first mechanical thigh 111 is connected to the first mechanical calf 112 in a sleeved manner. In some embodiments, when being in a sleeved state, the first mechanical thigh 111 is nested inside the first mechanical calf 112, and in an extension and shortening process, the first mechanical thigh 111 extends and shortens along a sleeved direction. In some embodiments, when being in a sleeved state, the first mechanical calf 112 is nested inside the first mechanical calf 111, and in an extension and shortening process, the first mechanical calf 112 extends and shortens along a sleeved direction (cases shown in FIG. 1 and FIG. 2). In some embodiments, when being in a sleeved state, the first mechanical thigh 111 and the first mechanical calf 112 are nested inside an intermediate component, and in an extension and shortening process, the first mechanical thigh 111 and the first mechanical calf 112 extend and shorten along a sleeved direction.

The second swing leg 21 includes a second mechanical thigh 211 and a second mechanical calf 212, and the second mechanical thigh 211 is connected to the second mechanical calf 212 in a sleeved manner. In some embodiments, when being in a sleeved state, the second mechanical thigh 211 is nested inside the second mechanical calf 212, and in an extension and shortening process, the second mechanical thigh 211 extends and shortens along a sleeved direction. In some embodiments, when being in a sleeved state, the second mechanical calf 212 is nested inside the second mechanical thigh 211, and in an extension and shortening process, the second mechanical calf 212 extends and shortens along a sleeved direction (cases shown in FIG. 1 and FIG. 2). In some embodiments, when being in a sleeved state, the second mechanical thigh 211 and the second mechanical calf 212 are nested inside an intermediate component, and in an extension and shortening process, the second mechanical thigh 211 and the second mechanical calf 212 extend and shorten along a sleeved direction.

In some embodiments, the mobile robot further includes a first extension and shortening motor corresponding to the first swing leg 11 and a second extension and shortening motor corresponding to the second swing leg 21. The first extension and shortening motor is configured to drive the first swing leg 11 to extend and shorten along the sleeved direction. The second extension and shortening motor is configured to drive the second swing leg 21 to extend and shorten along the sleeved direction. In some embodiments, the first extension and shortening motor is a first linear motor. In some embodiments, the first extension and shortening motor is a motor designed to implement linear transmission by using a lead screw nut. In some embodiments, the second extension and shortening motor is a second linear motor. In some embodiments, the second extension and shortening motor is a motor designed to implement linear transmission by using a lead screw nut.

In some embodiments, a plurality of first extension and shortening motors respectively corresponding to the plurality of first swing legs 11 support controlling the plurality of first swing legs 11 to extend and shorten in a linked manner or independently. In some embodiments, a plurality of second extension and shortening motors respectively corresponding to the plurality of second swing legs 21 support controlling the plurality of second swing legs 21 to extend and shorten in a linked manner or independently.

In some embodiments, the first swing leg 11 includes a first mechanical thigh 111 and a first mechanical calf 112, and the first mechanical thigh 111 is rotatably connected to the first mechanical calf 112 by using a first knee joint rotation shaft. The first knee joint rotation shaft supports increasing or decreasing an included angle between the first mechanical thigh 111 and the first mechanical calf 112. The second swing leg 21 includes a second mechanical thigh 211 and a second mechanical calf 212, and the second mechanical thigh 211 is rotatably connected to the second mechanical calf 212 by using a second knee joint rotation shaft. The second knee joint rotation shaft supports increasing or decreasing an included angle between the second mechanical thigh 211 and the second mechanical calf 212.

In some embodiments, the first swing leg group 10 includes a plurality of first swing legs 11, and the first swing leg 11 includes a first leg assembly and a first wheel 113 located at a tail end of the first leg assembly. The second swing leg group 20 includes a plurality of second swing legs 21, and the second swing leg 21 includes a second leg assembly and a second wheel 213 located at a tail end of the second leg assembly. In some embodiments, the first wheel 113 is a wheel having a multi-directional degree of freedom. The first wheel 113 supports rotation in any direction. In some embodiments, the second wheel 213 is a wheel having a multi-directional degree of freedom. The second wheel 213 supports rotation in any direction. With reference to FIG. 1 and FIG. 2, the first leg assembly includes the first mechanical thigh 111 and the first mechanical calf 112, and the second leg assembly includes the second mechanical thigh 211 and the second mechanical calf 212.

In some embodiments, the mobile robot further includes a first drive motor corresponding to the first wheel 113 and a second drive motor corresponding to the second wheel 213. The first drive motor is configured to drive the first wheel 113 to rotate. The second drive motor is configured to drive the second wheel 213 to rotate.

In some embodiments, a plurality of first drive motors respectively corresponding to the plurality of first swing legs 11 support controlling a plurality of first wheels 113 to rotate in a linked manner or independently. In some embodiments, a plurality of second drive motors respectively corresponding to the plurality of second swing legs 21 support controlling a plurality of second wheels 213 to rotate in a linked manner or independently.

In some embodiments, the mobile robot further includes a waist structure 30 and a torso structure 40. The waist structure 30 is configured to connect a leg structure and the torso structure 40, and the leg structure includes the first swing leg group 10 and the second swing leg group 20.

In some embodiments, the waist structure 30 includes a pitch rotation shaft 3. The pitch rotation shaft 3 is parallel to a rotation shaft of the first swing leg group 10, and/or the pitch rotation shaft 3 is parallel to a rotation shaft of the second swing leg group 20. Exemplarily, with reference to FIG. 1 and FIG. 2, the pitch rotation shaft 3 is parallel to the first hip rotation shaft 1 (and the second hip rotation shaft 2). The pitch rotation shaft 3 is rotatably connected to the torso structure 40, and the pitch rotation shaft 3 is configured to support the torso structure 40 in performing a pitch operation.

In some embodiments, the waist structure 30 includes a side swing rotation shaft 4. The side swing rotation shaft 4 is perpendicular to a rotation shaft of the first swing leg group 10, and/or the side swing rotation shaft 4 is perpendicular to a rotation shaft of the second swing leg group 20. With reference to FIG. 1 and FIG. 2, the side swing rotation shaft 4 is perpendicular to the first hip rotation shaft 1 (and the second hip rotation shaft 2). The side swing rotation shaft 4 is rotatably connected to the torso structure 40, and the side swing rotation shaft 4 is configured to support the torso structure 40 in performing a side swing operation.

In some embodiments, the waist structure 30 includes a pitch rotation shaft 3 and a side swing rotation shaft 4. The pitch rotation shaft 3 is parallel to a rotation shaft of the first swing leg group 10, and/or the pitch rotation shaft 3 is parallel to a rotation shaft of the second swing leg group 20. With reference to FIG. 1 and FIG. 2, the pitch rotation shaft 3 is parallel to the first hip rotation shaft 1 (and the second hip rotation shaft 2). The pitch rotation shaft 3 is configured to support the torso structure 40 in performing a pitch operation. The side swing rotation shaft 4 is perpendicular to the pitch rotation shaft 3. A first end 41 of the side swing rotation shaft 4 is connected to a center of the pitch rotation shaft 3, a second end 42 of the side swing rotation shaft 4 is connected to the torso structure 40, and the side swing rotation shaft 4 is configured to support the torso structure 40 in performing a side swing operation.

In some embodiments, the mobile robot further has at least one operation arm 50. With reference to FIG. 1 and FIG. 2, FIG. 1 and FIG. 2 show that the mobile robot has two operation arms 50, and the two operation arms 50 are symmetrically distributed along a central axis of the robot.

In some embodiments, the operation arm 50 is connected to a shoulder rotation shaft 5 of the mobile robot. The shoulder rotation shaft 5 is configured to support the operation arm 50 in having a multi-directional rotation degree of freedom. In some embodiments, the shoulder rotation shaft 5 supports rotation of the operation arm 50 within a rotation angle range allowed by a structure of the robot. In some embodiments, the mobile robot further includes a shoulder drive motor corresponding to the shoulder rotation shaft 5. The shoulder drive motor is configured to drive the operation arm 50 to rotate. In some embodiments, a plurality of shoulder drive motors respectively corresponding to a plurality of shoulder rotation shafts 5 support controlling a plurality of operation arms 50 to rotate in a linked manner or independently.

In some embodiments, the operation arm 50 includes a mechanical upper arm 51 and a mechanical forearm 52, the mechanical upper arm 51 and the mechanical forearm 52 are connected by using an elbow joint rotation shaft 6, and the elbow joint rotation shaft 6 is configured to support the mechanical forearm 52 in having a multi-directional rotation degree of freedom. In some embodiments, the elbow joint rotation shaft 6 supports rotation of the mechanical forearm 52 within a rotation angle range allowed by a structure of the robot. In some embodiments, the mobile robot further includes an elbow joint drive motor corresponding to the elbow joint rotation shaft 6. The elbow joint drive motor is configured to drive the mechanical forearm 52 to rotate. In some embodiments, a plurality of elbow joint drive motors respectively corresponding to a plurality of elbow joint rotation shafts 6 support controlling a plurality of mechanical forearms 52 to rotate in a linked manner or independently.

In some embodiments, a mechanical apparatus is connected to a tail end of the mechanical forearm 52, for example: a mechanical hand providing a grabbing function, a magnetic sucker providing an adsorption capability, or a bionic hand providing a bionic motion capability. In some embodiments, the mobile robot further has a head 60, and the head 60 is located above the torso structure 40.

The detailed structure of the mobile robot is described above. The following describes a method for controlling a robot. The method for controlling a robot is performed by a computer device.

In some embodiments, at least three swing legs are controlled to execute a leg action on a reference plane. In some embodiments, the mobile robot includes the at least three swing legs, the at least three swing legs being distributed side by side, and rotation shafts of the at least three swing legs being located on the same vertical plane.

In some embodiments, a control signal is obtained; and the at least three swing legs are controlled based on the control signal, to execute a leg action on a reference plane. In some embodiments, the mobile robot includes the at least three swing legs, the at least three swing legs being distributed side by side, and rotation shafts of the at least three swing legs being located on the same vertical plane.

In some embodiments, the control signal includes a first control signal and a second control signal, and the first control signal is used for controlling a second swing leg group or a second swing leg; and the second control signal is used for controlling a first swing leg group or a first swing leg.

In some embodiments, the first control signal includes, but is not limited to, at least one of a rotation angle instruction, a rotation speed instruction, and a rotation torque instruction.

In some embodiments, the second control signal includes, but is not limited to, at least one of a rotation angle instruction, a rotation speed instruction, and a rotation torque instruction.

In some embodiments, the at least three swing legs are controlled to be close on the reference plane and together support standing. In some embodiments, the at least three swing legs are controlled to be close on the reference plane and at least two swing legs together support standing. In some embodiments, the at least three swing legs are controlled to be bifurcated to stand, and at least three contact points of the at least three swing legs on the reference plane encircle a geometric figure.

In some embodiments, at least one of the at least three swing legs is controlled to take a step once.

In some embodiments, at least one of the at least three swing legs is controlled to execute a treading action once.

In some embodiments, at least one of the at least three swing legs is controlled to execute a split action once.

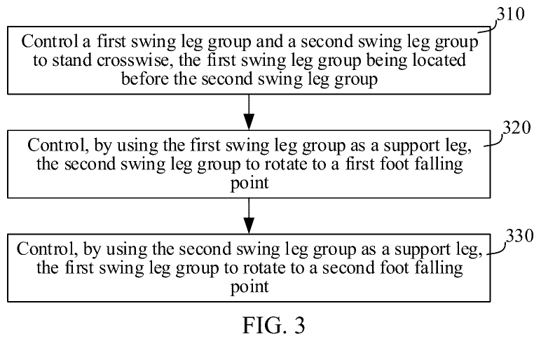

FIG. 3 is a flowchart of a method for controlling a mobile robot according to some embodiments. An example in which the method is performed by a computer device is used for description. The method includes the following operations.

Operation 310: Control a first swing leg group and a second swing leg group to stand crosswise, the first swing leg group being located before the second swing leg group.

In some embodiments, at least three swing legs of the mobile robot include the first swing leg group and the second swing leg group. In some embodiments, the first swing leg group includes a plurality of first swing legs, and at least two of the plurality of first swing legs are respectively located on two sides of a center of gravity of the mobile robot; and the second swing leg group includes a plurality of second swing legs, and at least two of the plurality of second swing legs are respectively located on the two sides of the center of gravity of the mobile robot. In some embodiments, the first swing leg group includes a plurality of first swing legs, and at least two of the plurality of first swing legs are respectively located on two sides of a center of gravity of the mobile robot; and the second swing leg group includes one second swing leg, and the one second swing leg is located on a central axis of the mobile robot. In some embodiments, the first swing leg group includes one first swing leg, and the one first swing leg is located on a central axis of the mobile robot; and the second swing leg group includes a plurality of second swing legs, and at least two of the plurality of second swing legs are respectively located on two sides of a center of gravity of the mobile robot.

In an initial posture of travelling in a crossed gait, the first swing leg group and the second swing leg group of the mobile robot are controlled to stand crosswise. In some embodiments, the case in which the first swing leg group is located before the second swing leg group is described, and similarly, a solution in which the second swing leg group is located before the first swing leg group may be derived.

Operation 320: Control, by using the first swing leg group as a support leg, the second swing leg group to rotate to a first foot falling point.

The first foot falling point is a first foot falling point of the mobile robot in a travelling process, compared with a position of the mobile robot in an initial posture of standing crosswise.

In some embodiments, the second swing leg group is controlled, based on a first control signal by using the first swing leg group as the support leg, to rotate to the first foot falling point.

In some embodiments, the second swing leg group is controlled, by using the first swing leg group as the support leg, to rotate about a second hip rotation shaft, until the second swing leg group rotates to the first foot falling point.

In some embodiments, the first swing leg group is determined as the support leg; a second rotation instruction is transmitted to a second rotation motor; and the second rotation motor is controlled, based on the second rotation instruction, to drive the second swing leg group to rotate about the second hip rotation shaft, until the second swing leg group rotates to the first foot falling point. In some embodiments, the second rotation instruction includes a rotation angle instruction, a rotation speed instruction, and a rotation torque instruction. Exemplarily, a forward swing leg is in a positive direction, and a backward swing leg is in a negative direction, so that the rotation angle instruction is 90°.

In some embodiments, the first swing leg group is used as the support leg; a plurality of fourth rotation instructions are transmitted to a plurality of fourth rotation motors respectively corresponding to the plurality of second swing legs; and the plurality of fourth rotation motors are controlled, based on the plurality of fourth rotation instructions, to drive the plurality of second swing legs to rotate about the second hip rotation shaft, until the plurality of second swing legs rotate to the first foot falling point. In some embodiments, the fourth rotation instruction includes a rotation angle instruction, a rotation speed instruction, and a rotation torque instruction. Exemplarily, a forward swing leg is in a positive direction, and a backward swing leg is in a negative direction, so that the rotation angle instruction is 90°.

Operation 330: Control, by using the second swing leg group as a support leg, the first swing leg group to rotate to a second foot falling point.

The second foot falling point is a second foot falling point of the mobile robot in a travelling process, compared with a position of the mobile robot in an initial posture of standing crosswise.

In some embodiments, the first swing leg group is controlled, based on a second control signal by using the second swing leg group as the support leg, to rotate to the second foot falling point.

In some embodiments, the first swing leg group is controlled, by using the second swing leg group as the support leg, to rotate about a first hip rotation shaft, until the first swing leg group rotates to the second foot falling point.

In some embodiments, the second swing leg group is determined as the support leg; a first rotation instruction is transmitted to a first rotation motor; and the first rotation motor is controlled, based on the first rotation instruction, to drive the first swing leg group to rotate about the first hip rotation shaft, until the first swing leg group rotates to the second foot falling point. In some embodiments, the first rotation instruction includes a rotation angle instruction, a rotation speed instruction, and a rotation torque instruction. Exemplarily, a forward swing leg is in a positive direction, and a backward swing leg is in a negative direction, so that the rotation angle instruction is 90°.

In some embodiments, the second swing leg group is used as the support leg; a plurality of third rotation instructions are transmitted to a plurality of third rotation motors respectively corresponding to the plurality of first swing legs; and the plurality of third rotation motors are controlled, based on the plurality of third rotation instructions, to drive the plurality of first swing legs to rotate about the first hip rotation shaft, until the plurality of first swing legs rotate to the second foot falling point. In some embodiments, the third rotation instruction includes a rotation angle instruction, a rotation speed instruction, and a rotation torque instruction. Exemplarily, a forward swing leg is in a positive direction, and a backward swing leg is in a negative direction, so that the rotation angle instruction is 90°.

Based on some embodiments shown in FIG. 3, the method further includes: controlling a first mechanical thigh and a first mechanical calf to extend and shorten along a sleeved direction; and/or controlling a second mechanical thigh and a second mechanical calf to extend and shorten along a sleeved direction. The first swing leg of the mobile robot includes the first mechanical thigh and the first mechanical calf, and the first mechanical thigh is connected to the first mechanical calf in a sleeved manner; and the second swing leg of the mobile robot includes the second mechanical thigh and the second mechanical calf, and the second mechanical thigh is connected to the second mechanical calf in a sleeved manner.

In some embodiments, a first extension and shortening instruction is transmitted to a first extension and shortening motor; and the first extension and shortening motor is controlled, based on the first extension and shortening instruction, to drive the first mechanical thigh and the first mechanical calf to extend and shorten along a sleeved direction. In some embodiments, the first extension and shortening motor is a first linear motor. In some embodiments, the first extension and shortening motor is a motor designed to implement linear transmission by using a lead screw nut. In some embodiments, the first extension and shortening instruction includes a linear movement position instruction, a linear movement speed instruction, and a driving force instruction.

In some embodiments, a second extension and shortening instruction is transmitted to a second extension and shortening motor; and the second extension and shortening motor is controlled, based on the second extension and shortening instruction, to drive the second mechanical thigh and the second mechanical calf to extend and shorten along a sleeved direction. In some embodiments, the second extension and shortening motor is a second linear motor. In some embodiments, the second extension and shortening motor is a motor designed to implement linear transmission by using a lead screw nut. In some embodiments, the second extension and shortening instruction includes a linear movement position instruction, a linear movement speed instruction, and a driving force instruction.

Based on some embodiments shown in FIG. 3, the method further includes: controlling at least one first wheel respectively corresponding to at least one first swing leg in the first swing leg group to rotate; and/or controlling at least one second wheel respectively corresponding to at least one second swing leg in the second swing leg group to rotate. The first swing leg includes a first leg assembly and the first wheel located at a tail end of the first leg assembly, and the second swing leg includes a second leg assembly and the second wheel located at a tail end of the second leg assembly.

In some embodiments, at least one first drive instruction is transmitted to at least one first drive motor respectively corresponding to the at least one first swing leg in the first swing leg group; and the at least one first wheel is driven, based on the at least one first drive instruction by using the at least one first drive motor, to rotate. In some embodiments, at least one second drive instruction is transmitted to at least one second drive motor respectively corresponding to the at least one second swing leg in the second swing leg group; and the at least one second wheel is driven, based on the at least one second drive instruction by using the at least one second drive motor, to rotate. In some embodiments, the first drive instruction includes a rotation angle instruction, a rotation speed instruction, and a rotation torque instruction. In some embodiments, the second drive instruction includes a rotation angle instruction, a rotation speed instruction, and a rotation torque instruction.

Based on some embodiments shown in FIG. 3, the method further includes: controlling a torso structure by using a waist structure, to perform a pitch operation and/or a side swing operation. The mobile robot further includes the waist structure and the torso structure. The waist structure is configured to connect a leg structure and the torso structure, and the leg structure includes the first swing leg group and the second swing leg group.

In some embodiments, a pitch rotation shaft is controlled to rotate, to control the torso structure to perform a pitch operation. The waist structure includes the pitch rotation shaft; the pitch rotation shaft is parallel to a rotation shaft of the first swing leg group, and/or the pitch rotation shaft is parallel to a rotation shaft of the second swing leg group; and the pitch rotation shaft is rotatably connected to the torso structure.

In some embodiments, a side swing rotation shaft is controlled to rotate, to control the torso structure to perform a side swing operation. The waist structure includes the side swing rotation shaft; the side swing rotation shaft is perpendicular to a rotation shaft of the first swing leg group, and/or the side swing rotation shaft is perpendicular to a rotation shaft of the second swing leg group; and the side swing rotation shaft is rotatably connected to the torso structure.

In some embodiments, a pitch rotation shaft is controlled to rotate, to control the torso structure to perform a pitch operation; and/or a side swing rotation shaft is controlled to rotate, to control the torso structure to perform a side swing operation. The waist structure includes the pitch rotation shaft and the side swing rotation shaft; the pitch rotation shaft is parallel to a rotation shaft of the first swing leg group, and/or the pitch rotation shaft is parallel to a rotation shaft of the second swing leg group; and the side swing rotation shaft is perpendicular to the pitch rotation shaft. A first end of the side swing rotation shaft is connected to a center of the pitch rotation shaft, and a second end of the side swing rotation shaft is connected to the torso structure.

Based on some embodiments shown in FIG. 3, the method further includes: controlling a shoulder rotation shaft to rotate, to control an operation arm to freely rotate in multiple directions. The mobile robot further has at least one operation arm, and the operation arm is connected to the shoulder rotation shaft of the mobile robot. In some embodiments, the operation arm includes a mechanical upper arm and a mechanical forearm. The mechanical upper arm is connected to the mechanical forearm by using an elbow joint rotation shaft. The method further includes: controlling the elbow joint rotation shaft to rotate, to control the mechanical forearm to freely rotate in multiple directions.

Several methods for controlling a mobile robot are further described below. The method for controlling a robot is performed by a computer device.

### Control the First Swing Leg Group and the Second Swing Leg Group to Stand Close.

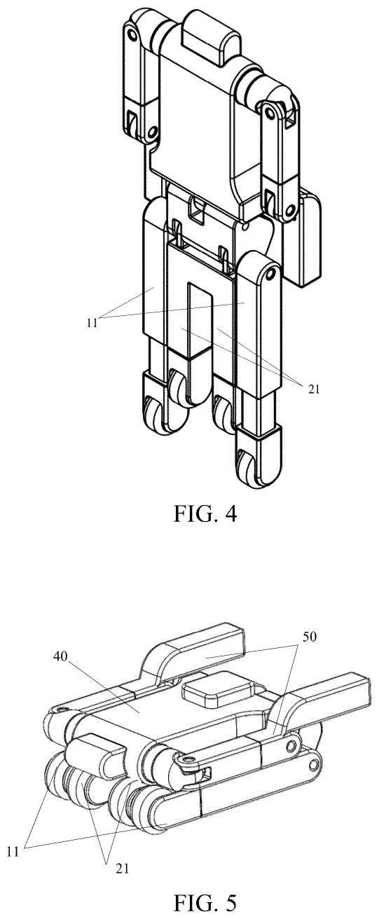

With reference to FIG. 4, FIG. 4 shows a standing mode in which the first swing leg group 10 of the mobile robot comes into contact with a horizontal reference plane. In this case, a plurality of first swing legs 11 in the first swing leg group 10 are in an extended state, and a plurality of second swing legs 21 in the second swing leg group 20 are in a shortened state.

In some embodiments, the second swing leg group 20 of the mobile robot may alternatively come into contact with the horizontal reference plane. In this case, the plurality of second swing legs 21 in the second swing leg group 20 are in an extended state, and the plurality of first swing legs 11 in the first swing leg group 10 are in a shortened state.

In some embodiments, both the first swing leg group 10 and the second swing leg group 20 of the mobile robot come into contact with the horizontal reference plane. In this case, the plurality of first swing legs 11 and the plurality of second swing legs 21 are all in an extended state, or the plurality of first swing legs 11 and the plurality of second swing legs 21 are all in a shortened state.

It is to be understood that when legs of the robot stand close, an area occupied by the robot may be reduced, thereby facilitating the robot passing through narrow space. A zero-radius turning of the robot may be implemented based on settings of a leg wheel. When movement is performed on a narrow and flat ground, the movement may be performed by standing close and driving wheels at tail ends of legs.

### Control the First Swing Leg Group and the Second Swing Leg Group to Stand Crosswise.

FIG. 1 and FIG. 2 show a mode of standing crosswise in which both the first swing leg group 10 and the second swing leg group 20 of the mobile robot come into contact with a horizontal reference plane. In some embodiments, in the mode of standing crosswise, an angle θ between the first swing leg group 10 and the second swing leg group 20 may be any angle (for example, 40 degrees) limited by a mechanical structure, so that a horizontal operational range of the robot after a position is fixed can be adjusted. The angle θ between the first swing leg group 10 and the second swing leg group 20 is changed, so that an area of a foot print of the mobile robot can be changed, thereby adjusting the stability of the robot. In some embodiments, in the mode of standing crosswise, the first swing leg group 10 and the second swing leg group 20 may extend or shorten, to adjust a height operational range of the robot after a position is fixed.

It is to be understood that, when moving on a wide and flat ground, the robot may move in the mode of standing crosswise and by driving wheels of the two swing leg groups.

### Control the First Swing Leg Group and the Second Swing Leg Group to Travel in a Crossed Gait.

When moving on a non-flat ground, the robot may travel in the crossed gait by using the two swing leg groups, and the two swing leg groups travel alternately. When the structure of the robot is described above, a detailed gait of the robot during travelling crosswise is described, and is not described herein again.

In some embodiments, the first swing leg group 10 rotates about a first hip rotation shaft 1. A first rotation motor drives the first swing leg group 10 to rotate about the first hip rotation shaft 1. The first rotation motor receives a rotation angle instruction, a rotation speed instruction, and a rotation torque instruction, and a bottom-layer drive board of the first rotation motor drives, based on a received instruction signal, the first rotation motor to rotate.

In some embodiments, the second swing leg group 20 rotates about a second hip rotation shaft 2. A second rotation motor drives the second swing leg group 20 to rotate about the second hip rotation shaft 2. The second rotation motor receives a rotation angle instruction, a rotation speed instruction, and a rotation torque instruction, and a bottom-layer drive board of the second rotation motor drives, based on a received instruction signal, the second rotation motor to rotate.

Control the First Swing Leg and/or the Second Swing Leg to Extend and Shorten.

In some embodiments, the first swing leg group 10 includes a plurality of first swing legs 11. The first swing leg includes a first mechanical thigh 111 and a first mechanical calf 112 that are connected in a sleeved manner. The plurality of first swing legs 11 are respectively corresponding to a plurality of first extension and shortening motors, and the first extension and shortening motor is configured to drive the first swing leg 11 to extend and shorten along a sleeved direction. A bottom-layer drive board of the first extension and shortening motor receives a linear movement position instruction, a linear movement speed instruction, and a driving force instruction. The bottom-layer drive board of the first extension and shortening motor drives, based on a received instruction signal, the first extension and shortening motor to rotate. In some embodiments, the first extension and shortening motor is a first linear motor. In some embodiments, the first extension and shortening motor is a motor designed to implement linear transmission by using a lead screw nut.

In some embodiments, the second swing leg group 10 includes a plurality of second swing legs 21. The second swing leg includes a second mechanical thigh 211 and a second mechanical calf 212 that are connected in a sleeved manner. The plurality of second swing legs 21 are respectively corresponding to a plurality of second extension and shortening motors, and the second extension and shortening motor is configured to drive the second swing leg 21 to extend and shorten along a sleeved direction. A bottom-layer drive board of the second extension and shortening motor receives a linear movement position instruction, a linear movement speed instruction, and a driving force instruction. The bottom-layer drive board of the second extension and shortening motor drives, based on a received instruction signal, the second extension and shortening motor to rotate. In some embodiments, the second extension and shortening motor is a second linear motor. In some embodiments, the second extension and shortening motor is a motor designed to implement linear transmission by using a lead screw nut.

Control the First Swing Leg and/or the Second Swing Leg to Rotate and Travel by Using Wheels at Tail Ends of the Legs.

In some embodiments, the first swing leg group 10 includes a plurality of first swing legs 11. The tail end of the first swing leg 11 includes a first wheel 113. The plurality of first swing legs 11 are respectively corresponding to a plurality of first drive motors, and the first drive motor is configured to drive the first wheel 113 to rotate. A bottom-layer drive board of the first drive motor receives a rotation angle instruction, a rotation speed instruction, and a rotation torque instruction, and the bottom-layer drive board of the first drive motor drives, based on a received instruction signal, the first drive motor to rotate.

In some embodiments, the second swing leg group 20 includes a plurality of second swing legs 21. The tail end of the second swing leg 21 includes a second wheel 213. The plurality of second swing legs 21 are respectively corresponding to a plurality of second drive motors, and the second drive motor is configured to drive the second wheel 213 to rotate. A bottom-layer drive board of the second drive motor receives a rotation angle instruction, a rotation speed instruction, and a rotation torque instruction, and the bottom-layer drive board of the second drive motor drives, based on a received instruction signal, the second drive motor to rotate.

Control the Mobile Robot to Perform a Pitch Operation and/or a Side Swing Operation.

The mobile robot performs a pitch operation by using a pitch rotation shaft 3, and the pitch rotation shaft 3 is rotatably connected to a torso structure of the mobile robot. The pitch rotation shaft 3 is driven by using a pitch rotation motor. In some embodiments, a bottom-layer drive board of the pitch rotation motor receives a rotation angle instruction, a rotation speed instruction, and a rotation torque instruction, and the bottom-layer drive board of the pitch rotation motor drives, based on a received instruction signal, the pitch rotation motor to rotate.

The mobile robot performs a side swing operation by using a side swing rotation shaft 4, and the side swing rotation shaft 4 is rotatably connected to the torso structure of the mobile robot. The side swing rotation shaft 4 is driven by using a side swing rotation motor. In some embodiments, a bottom-layer drive board of the side swing rotation motor receives a rotation angle instruction, a rotation speed instruction, and a rotation torque instruction, and the bottom-layer drive board of the side swing rotation motor drives, based on a received instruction signal, the side swing rotation motor to rotate.

### Control the Mobile Robot to Rotate an Operation Arm.

The mobile robot includes at least one operation arm, and the at least one operation arm is in a one-to-one correspondence with at least one shoulder rotation shaft. In some embodiments, the mobile robot rotates the operation arm by using a shoulder rotation shaft 5, and the shoulder rotation shaft 5 is rotatably connected to the operation arm of the mobile robot. The shoulder rotation shaft 5 is driven by using a shoulder rotation motor. In some embodiments, a bottom-layer drive board of the shoulder rotation motor receives a rotation angle instruction, a rotation speed instruction, and a rotation torque instruction, and the bottom-layer drive board of the shoulder rotation motor drives, based on a received instruction signal, the shoulder rotation motor to rotate.

### Control the Mobile Robot to Rotate a Mechanical Forearm.

The operation arm includes a mechanical upper arm and a mechanical forearm. The mechanical upper arm is connected to the mechanical forearm by using an elbow joint rotation shaft. The elbow joint rotation shaft 6 is driven by using an elbow joint rotation motor. In some embodiments, a bottom-layer drive board of the elbow joint rotation motor receives a rotation angle instruction, a rotation speed instruction, and a rotation torque instruction, and the bottom-layer drive board of the elbow joint rotation motor drives, based on a received instruction signal, the elbow joint rotation motor to rotate.

### Control the Mobile Robot to Fold.

FIG. 5 is a schematic diagram of folding of a robot according to some embodiments. After the folding, a plurality of first swing legs 11 included in a first swing leg group and a plurality of second swing legs 21 included in a second swing leg group of the robot are horizontally close, a front surface (or a back surface) of a torso structure 40 of the robot is adhered to a top surface of the first swing leg group 11 (or the second swing leg group 21), and an operation arm 50 of the robot is adhered to the torso structure 40. The mobile robot controls rotation and/or movement of each joint by using a control motor of the joint, to control the mobile robot to fold into a state shown in FIG. 5.

### Control the Mobile Robot to Execute a Task.

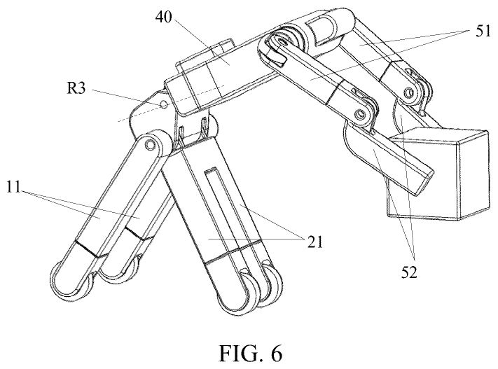

FIG. 6 is a schematic diagram when a robot executes an operation task. FIG. 6 shows a posture of standing crosswise of a plurality of first swing legs 11 and a plurality of second swing legs 21 of a mobile robot. A torso structure 40 of the robot executes, by using a pitch rotation shaft 3, a pitch posture generated after a bending operation. The robot holds a target object by using two operation arms 50 (including a mechanical upper arm 51 and a mechanical forearm 52).

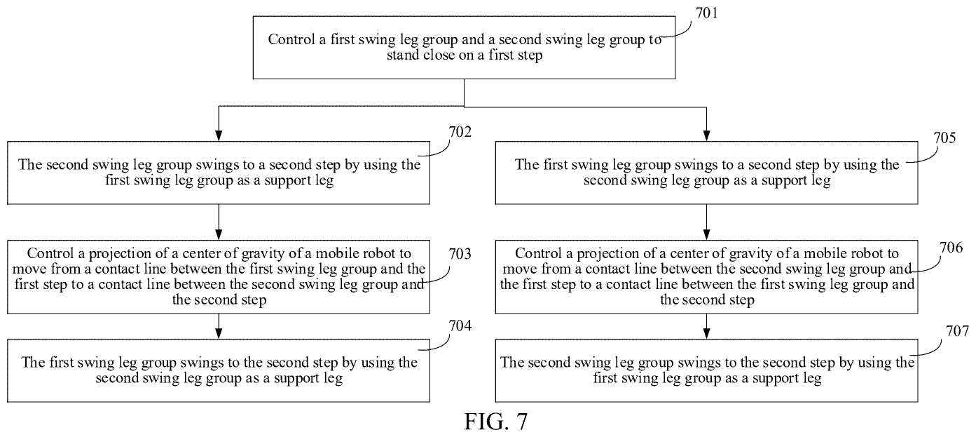

In some embodiments, FIG. 7 is a flowchart of a method for controlling a mobile robot to ascending/descending a staircase. The method is performed by a computing device, and includes the following operations:

Operation 701: Control a first swing leg group and a second swing leg group to stand close on a first step.

A plurality of first swing legs in the first swing leg group and a plurality of second swing legs in the second swing leg group stand close. In some embodiments, both the first swing leg group and the second swing leg group come into contact with the first step. In some embodiments, the first swing leg group comes into contact with the first step but the second swing leg group comes into no contact with the first step. In some embodiments, the second swing leg group comes into contact with the first step but the first swing leg group comes into no contact with the first step.

In some embodiments, the first step is a lower step, and a second step is an upper step. When the mobile robot is controlled to go upstairs, the first step is a lower step and the second step is an upper step. When the mobile robot is controlled to descend a staircase, the first step is an upper step and the second step is a lower step.

Operation 702: The second swing leg group swings to the second step by using the first swing leg group as a support leg.

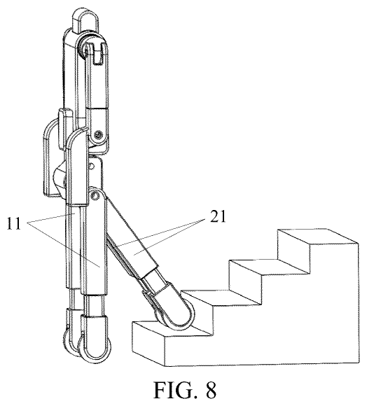

When the mobile robot is controlled to ascend a staircase, and only the first swing leg group comes into contact with the first step in operation 701, the second swing leg group swings to the second step by using the first swing leg group as the support leg. FIG. 8 shows a state of the mobile robot after the second swing leg group swings to the second step. In this case, the plurality of first swing legs 11 in the first swing leg group 10 is located on a lower step (the first step), and the plurality of second swing legs 21 in the second swing leg group 20 is located on an upper step (the second step). As shown in FIG. 8, the plurality of first swing legs 11 are in an extended state, and the plurality of second swing legs 21 are in an extended state.

Operation 703: Control a projection of a center of gravity of the mobile robot to move from a contact line between the first swing leg group and the first step to a contact line between the second swing leg group and the second step.

The first swing leg group includes a plurality of first swing legs. A plurality of contact points between the plurality of first swing legs and the first step are connected in series, to obtain the contact line between the first swing leg group and the first step. The second swing leg group includes a plurality of second swing legs. A plurality of contact points between the plurality of second swing legs and the second step are connected in series, to obtain the contact line between the second swing leg group and the second step. The projection of the center of gravity of the robot is moved from the contact line between the first swing leg group and the first step to the contact line between the second swing leg group and the second step.

Operation 704: The first swing leg group swings to the second step by using the second swing leg group as a support leg.

When the mobile robot is controlled to ascend a staircase, and after the second swing leg group swings to the second step, the first swing leg group swings to the second step by using the second swing leg group as the support leg.

Operation 705: The first swing leg group swings to the second step by using the second swing leg group as a support leg.

When the mobile robot is controlled to descend a staircase, and only the second swing leg group comes into contact with the first step in operation 701, the first swing leg group swings to the second step by using the second swing leg group as the support leg.

Operation 706: Control a projection of a center of gravity of the mobile robot to move from a contact line between the second swing leg group and the first step to a contact line between the first swing leg group and the second step.

The second swing leg group includes a plurality of second swing legs. A plurality of contact points between the plurality of second swing legs and the first step are connected in series, to obtain the contact line between the second swing leg group and the first step. The first swing leg group includes a plurality of first swing legs. A plurality of contact points between the plurality of first swing legs and the second step are connected in series, to obtain the contact line between the first swing leg group and the second step. The projection of the center of gravity of the robot is moved from the contact line between the second swing leg group and the first step to the contact line between the first swing leg group and the second step.

Operation 707: The second swing leg group swings to the second step by using the first swing leg group as a support leg.

After the first swing leg group swings to the second step, the second swing leg group swings to the second step by using the first swing leg group as the support leg.

In conclusion, an action sequence of the mobile robot ascending/descending a staircase is provided. After the center of gravity of the mobile robot is moved to a contact line between a front leg and the second step, a rear leg swings to the second step. A method for moving a center of gravity of the robot is provided, thereby improving the stability when the robot ascends/descends a staircase.

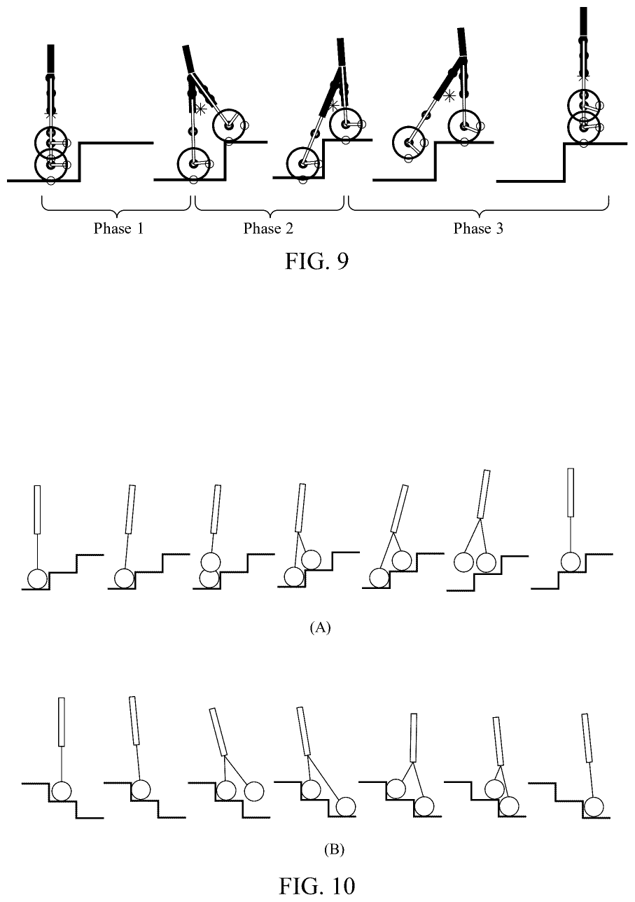

The method embodiment shown in FIG. 7 mainly relates to an obstacle spanning mode (ascending/descending a staircase) of a robot. According to FIG. 9 and FIG. 10, the following further describes, in detail, an action sequence used when the robot spans an obstacle.

In the mobile robot provided in some embodiments, at least two of a plurality of first swing legs are respectively located on two sides of a center of gravity; and at least two of a plurality of second swing legs are respectively located on the two sides of the center of gravity, so that the mobile robot may keep balance in a rolling direction, and the rolling direction is perpendicular to a travelling direction. Therefore, when the robot spans an obstacle by using a crossed gait, an action of the robot may be represented by using a plane model.

Two swing leg groups of the mobile robot shown in FIG. 9 completely overlap, and each leg in FIG. 9 represents one swing leg group of the robot. Two wheels in FIG. 9 respectively represent a wheel of a first swing leg group and a wheel of a second swing leg group of the robot. Next, the first swing leg group overlapping on a plane and the overlapping second swing leg group are described.

The first swing leg group and the second swing leg group are different in many aspects such as a position and a drive on the robot body, but may not be distinguished from each other in a specific action of ascending/descending a staircase, and the ascending/descending a staircase belongs to periodic motion. Therefore, specific correspondences between the support leg as well as the swing leg and the first swing leg group as well as the second swing leg group are not emphasized below. Because different quantities of contact points between the robot and the staircase affect a specific form of a dynamic model, phase division may be performed on actions of the robot in planning and control phases. In consideration of a specific form of a process of ascending and descending a staircase, the mobile robot in some embodiments completes a task of ascending and descending a staircase in a posture with a wheel landing.

Phases of the robot in the entire process are divided into a single support phase (SSP) and a double support phase (DSP).

A phase 1 shown in FIG. 9 is a single support phase. The support leg of the robot is always located on a step surface, and is cooperatively controlled by using a wheel and another joint of the robot, to keep balance. The swing leg is gradually raised in an initial vertical state by overcoming the gravity, until the swing leg is placed on an upper step, and a phase 2 is entered. The phase 2 is a double support phase.

In the phase 2, the robot always keeps, on the plane, both the wheels of the two swing leg groups in contact with step surfaces. In the phase 2, the robot changes an angle of a hip joint of an upper body. On the premise of keeping contact points between the wheels of the two swing leg groups and the ground not obviously changed, a projection of a center of mass of the upper body on the ground is gradually moved from a center of a rear wheel on a lower step to a center of a front wheel on the upper step. In addition, at any time, a leg and the rear wheel are ready to be raised from the lower step. Once the leg and the rear wheel are raised from the lower step, the phase 2 is switched to a phase 3, and the single support phase is entered again.

In the phase 3, the robot keeps balance by using the support leg, and raises, by overcoming the vertical-downward gravity, the swing leg placed on the lower step from the beginning, until the entire robot stably stands on the upper step by using a standing mode with a single leg group.

Through observation of the leftmost figure and the rightmost figure in FIG. 9, it may be found that the robot moves upward by one step, and the support leg and the swing leg are exchanged. Similarly, when the robot moves upward by another step, the support leg and the swing leg are exchanged again. So far, the complete periodic action of ascending a staircase is completed. For the action of descending a staircase, an action phase division of descending a staircase is the same as that of ascending a staircase, but planning of the action in a z direction is opposite. Details are not described herein again.

FIG. 10 is a schematic diagram of action sequences of a robot ascending and descending a staircase. Compared with FIG. 9, a part (A) of FIG. 10 shows the action sequence of the robot ascending a staircase in more details. A part (B) of FIG. 10 shows the action sequence of the robot descending a staircase.

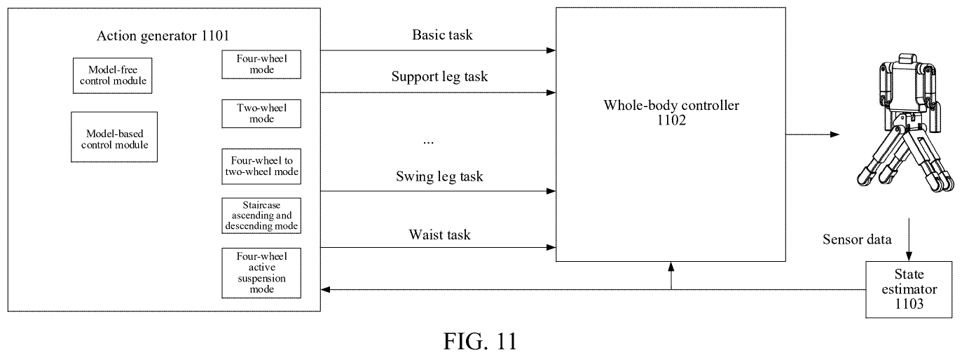

FIG. 11 is a block diagram of a method for controlling a mobile robot according to some embodiments. The mobile robot includes an action generator 1101, a whole-body controller (WBC) 1102, and a state estimator 1103.

The action generator 1101 obtains state data of the mobile robot transmitted by the state estimator 1103. A working mode of the robot is determined based on a current state of the mobile robot. Working modes of the robot include, but are not limited to: a four-wheel mode, a two-wheel mode, a four-wheel to two-wheel mode, a staircase ascending and descending mode, a four-wheel active suspension mode, and the like. In consideration of the complexity of an upper body of the mobile robot, there are more possible working modes of the robot. The four-wheel mode is a mode in which two first swing legs and two second swing legs of the mobile robot all come into contact with the ground. The two-wheel mode is a mode in which two first swing legs or two second swing legs of the mobile robot come into contact with the ground. The four-wheel to two-wheel mode is an intermediate mode in which the four-wheel mode is switched to the two-wheel mode. A staircase ascending and descending mode is a mode in which the mobile robot ascends or descends a staircase. The four-wheel active suspension mode is a mode in which two first swing legs and two second swing legs shorten.

In the different working modes, action generation manners of the mobile robot are different. Some common technical modules and algorithm modules are invoked in a plurality of working modes. FIG. 11 shows a model-free control module and a model-based control module. In some embodiments, the model-based control module includes a linear quadratic regulator (LQR) and a model predictive control (MPC).

Exemplarily, balance of a wheel may be controlled in the two-wheel mode, and reference tracks of the wheel and a center of mass of the robot are generated by using a proportional-integral-derivative control (PID) module of the model-free control module.

Exemplarily, in a two-wheel control phase in the four-wheel to two-wheel mode, a similar control module in the two-wheel mode is configured. Exemplarily, in the four-wheel mode, a wheel and a leg extending to a front side of the body are equivalent, and a wheel and a leg extending to a rear side of the body are equivalent. Equivalent wheels and legs and dynamics of the upper body may be described by using a first-order or second-order inverted pendulum. A module applied to balance control in the four-wheel mode may use a module applied to balance control in the two-wheel mode. A control track obtained in this way may keep balance of the robot in the four-wheel mode. If a road surface is uneven and a bump or an obstacle occurs, an action generated by the control module may implement the relative stability of the upper body of the robot. Exemplarily, for the four-wheel active suspension mode, a similar control module in the four-wheel mode is used.

The whole-body controller 1102 obtains some task information of the robot from the action generator 1101, including, but not limited to: a task of the center of mass, a support leg task, a swing leg task, a waist task, and the like. In consideration of the complexity of the upper body, the upper body may be configured to complete a plurality of actions and tasks, and the robot can include more tasks. The tasks are used as input of the whole-body controller 1102. The whole-body controller 1102 models and calibrates the robot in detail, uses a dynamic model and an external-force situation of the robot as optimized constraint conditions, and calculates a target joint angle instruction, a target joint angular velocity instruction, and a target joint torque instruction of each joint of the robot through an optimization process. Finally, the target joint angle instruction, the target joint angular velocity instruction, and the target joint torque instruction of each joint are transmitted to each joint driver of the robot, to drive each joint of the robot for execution.

For the state estimator 1103, states of the robot may be obtained by different sensors installed on a body of the robot. Exemplarily, a current posture of the robot may be obtained by using an inertial measurement unit (IMU) sensor. Rotation and movement positions and speed information of each joint of the robot in a current state may be obtained by using a motor encoder. Magnitudes and directions of a force and a torque that are applied to a joint at a current moment at which the sensor is located are obtained by using a force/torque sensor. A pressure magnitude of a sole, a body surface, a hand, and even a fingertip of the robot and a change feature within a period of time are obtained by using a tactile sensor. An obstacle in a field of view of the robot is recognized by using a visual sensor such as a camera, and state information of the robot is indirectly obtained.

A function of the state estimator 1103 is to fuse each posture and state information obtained by the robot. Exemplarily, a current posture of the robot obtained by using the IMU sensor, range information obtained through rotation of a wheel, and visual positioning information are fused to obtain a relatively accurate and trusted position of the robot in a world coordinate system. A contact situation between the robot and an external environment may be obtained by using the force/torque sensor and the tactile sensor. The current posture of the robot obtained by using the IMU sensor and angle information from each motor encoder are fused, to estimate a position of the center of mass of the robot with reference to a model parameter of the robot.

The state estimator 1103 uses, as a feedback amount, the robot state information obtained through fusion, and inputs the feedback amount to the action generator 1101 of the robot.

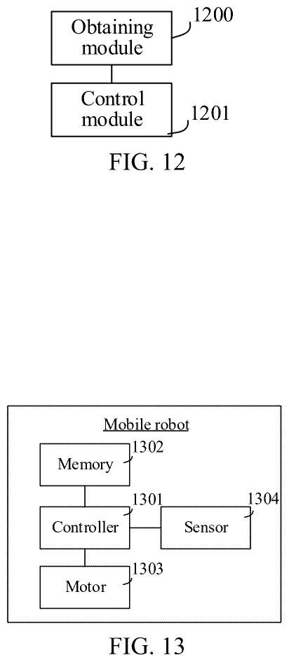

FIG. 12 is a structural block diagram of an apparatus for controlling a mobile robot according to some embodiments. The mobile robot includes at least three swing legs, the at least three swing legs are distributed side by side, and rotation shafts of the at least three swing legs are located on the same vertical plane. The control apparatus includes an obtaining module 1200 and a control module 1201. The obtaining module 1200 is configured to obtain a control signal. The control module 1201 is configured to control the at least three swing legs to execute a leg action on a reference plane.

The control module 1201 is configured to perform operations 310, 320, and 330 in FIG. 3.

In some embodiments, a first swing leg includes a first mechanical thigh and a first mechanical calf, and the first mechanical thigh is connected to the first mechanical calf in a sleeved manner. A second swing leg includes a second mechanical thigh and a second mechanical calf, and the second mechanical thigh is connected to the second mechanical calf in a sleeved manner. The control module 1201 is further configured to control the first mechanical thigh and the first mechanical calf to extend and shorten along a sleeved direction; and/or the control module 1201 is further configured to control the second mechanical thigh and the second mechanical calf to extend and shorten along a sleeved direction.

In some embodiments, the control module 1201 is further configured to: transmit a first extension and shortening instruction to a first extension and shortening motor; and control, based on the first extension and shortening instruction, the first extension and shortening motor to drive the first mechanical thigh and the first mechanical calf to extend and shorten along a sleeved direction. In some embodiments, the control module 1201 is further configured to: transmit a second extension and shortening instruction to a second extension and shortening motor; and control, based on the second extension and shortening instruction, the second extension and shortening motor to drive the second mechanical thigh and the second mechanical calf to extend and shorten along a sleeved direction.

In some embodiments, the first swing leg includes a first leg assembly and a first wheel located at a tail end of the first leg assembly, and the second swing leg includes a second leg assembly and the second wheel located at a tail end of the second leg assembly. The control module 1201 is further configured to control at least one first wheel respectively corresponding to at least one first swing leg in the first swing leg group to rotate; and/or the control module 1201 is further configured to control at least one second wheel corresponding to at least one second swing leg in the second swing leg group to rotate.

In some embodiments, the control module 1201 is further configured to: transmit at least one first drive instruction to at least one first drive motor respectively corresponding to the at least one first swing leg in the first swing leg group; and drive, based on the at least one first drive instruction by using the at least one first drive motor, the at least one first wheel to rotate.

In some embodiments, the control module 1201 is further configured to: transmit at least one second drive instruction to at least one second drive motor respectively corresponding to the at least one second swing leg in the second swing leg group; and drive, based on the at least one second drive instruction by using the at least one second drive motor, the at least one second wheel to rotate.

In some embodiments, the mobile robot further includes a waist structure and a torso structure; and the waist structure is configured to connect a leg structure and the torso structure, and the leg structure includes the first swing leg group and the second swing leg group. The control module 1201 is further configured to control the torso structure by using the waist structure, to perform a pitch operation and/or a side swing operation.

In some embodiments, the waist structure includes a pitch rotation shaft; the pitch rotation shaft is parallel to a rotation shaft of the first swing leg group, and/or the pitch rotation shaft is parallel to a rotation shaft of the second swing leg group; and the pitch rotation shaft is rotatably connected to the torso structure. The control module 1201 is further configured to control the pitch rotation shaft to rotate, to control the torso structure to perform a pitch operation.

In some embodiments, the waist structure includes a side swing rotation shaft; the side swing rotation shaft is perpendicular to a rotation shaft of the first swing leg group, and/or the side swing rotation shaft is perpendicular to a rotation shaft of the second swing leg group; and the side swing rotation shaft is rotatably connected to the torso structure. The control module 1201 is further configured to control the side swing rotation shaft to rotate, to control the torso structure to perform a side swing operation.

In some embodiments, the waist structure includes a pitch rotation shaft and a side swing rotation shaft; the pitch rotation shaft is parallel to a rotation shaft of the first swing leg group, and/or the pitch rotation shaft is parallel to a rotation shaft of the second swing leg group; and the side swing rotation shaft is perpendicular to the pitch rotation shaft. A first end of the side swing rotation shaft is connected to a center of the pitch rotation shaft, and a second end of the side swing rotation shaft is connected to the torso structure. The control module 1201 is further configured to: control the pitch rotation shaft to rotate, to control the torso structure to perform a pitch operation; and/or control the side swing rotation shaft to rotate, to control the torso structure to perform a side swing operation.

In some embodiments, the mobile robot further has at least one operation arm, and the operation arm is connected to a shoulder rotation shaft of the mobile robot. The control module 1201 is further configured to control the shoulder rotation shaft to rotate, to control the operation arm to freely rotate in multiple directions.

In some embodiments, the operation arm includes a mechanical upper arm and a mechanical forearm. The mechanical upper arm is connected to the mechanical forearm by using an elbow joint rotation shaft. The control module 1201 is further configured to control the elbow joint rotation shaft to rotate, to control the mechanical forearm to freely rotate in multiple directions.

According to some embodiments, each module or unit may exist respectively or be combined into one or more units. Some modules or units may be further split into multiple smaller function subunits, thereby implementing the same operations without affecting the technical effects of some embodiments. The modules or units are divided based on logical functions. In actual applications, a function of one module or unit may be realized by multiple modules or units, or functions of multiple modules or units may be realized by one module or unit. In some embodiments, the apparatus may further include other modules or units. In actual applications, these functions may also be realized cooperatively by the other modules or units, and may be realized cooperatively by multiple modules or units.

A person skilled in the art would understand that these “modules” or “units” could be implemented by hardware logic, a processor or processors executing computer software code, or a combination of both. The “modules” or “units” may also be implemented in software stored in a memory of a computer or a non-transitory computer-readable medium, where the instructions of each unit are executable by a processor to thereby cause the processor to perform the respective operations of the corresponding module or unit.

FIG. 13 is a structural block diagram of a mobile robot according to some embodiments. The mobile robot includes a controller 1301 and a memory 1302.

The controller 1301 may include one or more processing cores, such as a four-core processor or an eight-core processor. The controller 1301 may be implemented by using at least one hardware form of a digital signal processing (DSP), a field-programmable gate array (FPGA), and a programmable logic array (PLA). The controller 1301 may include a main processor and a coprocessor. The main processor is configured to process data in a woken-up state, and may be referred to as a central processing unit (CPU). The coprocessor is a low-power processor configured to process data in a standby state. In some embodiments, the controller 1301 may be integrated with a graphics processing unit (GPU). The GPU is configured to render and draw content that may be displayed on a display screen. In some embodiments, the controller 1301 may further include an artificial intelligence (AI) processor. The AI processor is configured to perform computing operations related to machine learning.

The memory 1302 may include one or more computer-readable storage media. The computer-readable storage medium may be non-transient. The memory 1302 may further include a high-speed random access memory and a nonvolatile memory, for example, one or more magnetic disk storage devices or flash storage devices. In some embodiments, the non-transitory computer-readable storage medium in the memory 1302 is configured to store at least one instruction, and the at least one instruction is used for being executed by the controller 1301 to implement the method for controlling a mobile robot provided in the method embodiments of this application.

In some embodiments, the mobile robot 1300 may further include at least one motor 1303 and at least one sensor 1304. The at least one motor 1303 is configured to: receive a control instruction transmitted by the controller 1301, and drive the mobile robot to execute an action. The at least one motor 1303 drives each joint of the mobile robot to execute an action such as rotation/extension and shortening/fixing. The at least one sensor 1304 is configured to obtain state information of the mobile robot. The state information includes an internal state of the mobile robot and/or an external state (environment information) of the mobile robot. The at least one sensor 1304 transmits the state information of the mobile robot to the controller 1301, to control the mobile robot to execute a related action.

A person skilled in the art may understand that the structure shown in FIG. 13 constitutes no limitation on the mobile robot 1300, and may include more or fewer components than those shown in the figure, or some components may be combined, or different component deployments may be used.

Some embodiments further provide a computer device. The computer device includes a memory and a processor. The memory has at least one piece of program code stored therein, and the program code is loaded and executed by the processor, to implement the above method for controlling a mobile robot.

Some embodiments further provide a computer-readable storage medium, the computer-readable storage medium having a computer program stored therein, and the computer program being executed by a processor, to implement the above method for controlling a mobile robot. Some embodiments further provide a chip, the chip including a programmable logic circuit and/or program instructions, and during running of the chip, being configured to implement the above method for controlling a mobile robot.

Some embodiments further provide a computer program product or a computer program, the computer program product or the computer program including computer instructions, the computer instructions being stored in a computer-readable storage medium, and a processor reading the computer instructions from the computer-readable storage medium and executing the computer instructions, to implement the above method for controlling a mobile robot.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A mobile robot, the mobile robot comprising: at least three swing legs distributed side by side.

2. The mobile robot according to claim 1, wherein the at least three swing legs are grouped into a first swing leg group and a second swing leg group; and
wherein at least one from among the first swing leg group and the second swing leg group comprises at least two swing legs respectively located on two sides of a center of gravity of the mobile robot.

3. The mobile robot according to claim 2, wherein
the first swing leg group comprises a plurality of first swing legs, and a plurality of the plurality of first swing legs are respectively located on the two sides of the center of gravity of the mobile robot;
the second swing leg group comprises one second swing leg that is located on a central axis of the mobile robot; and
the first swing leg group and the second swing leg group support travelling in a crossed gait.

4. The mobile robot according to claim 2, wherein
the first swing leg group comprises one first swing leg that is located on a central axis of the mobile robot;
the second swing leg group comprises a plurality of second swing legs, and at least two of the plurality of second swing legs are respectively located on the two sides of the center of gravity of the mobile robot; and
the first swing leg group and the second swing leg group support travelling in a crossed gait.

5. The mobile robot according to claim 2, wherein
the first swing leg group comprises a plurality of first swing legs, and at least two of the plurality of first swing legs are respectively located on the two sides of the center of gravity of the mobile robot;
the second swing leg group comprises a plurality of second swing legs, and at least two of the plurality of second swing legs are respectively located on the two sides of the center of gravity of the mobile robot; and
the first swing leg group and the second swing leg group support travelling in a crossed gait.

6. The mobile robot according to claim 5, wherein
the plurality of first swing legs are rotatably connected to a first hip rotation shaft of the mobile robot; and
the plurality of second swing legs are rotatably connected to a second hip rotation shaft of the mobile robot.

7. The mobile robot according to claim 6, wherein the first hip rotation shaft and the second hip rotation shaft are coaxial.

8. The mobile robot according to claim 7, wherein the mobile robot further comprises a first rotation motor for the first swing leg group and a second rotation motor for the second swing leg group, wherein
the first rotation motor is configured to drive the first swing leg group to rotate about the first hip rotation shaft in a linked manner; and
the second rotation motor is configured to drive the second swing leg group to rotate about the second hip rotation shaft in a linked manner.

9. The mobile robot according to claim 7, wherein the mobile robot further comprises a third rotation motor for the plurality of first swing legs and a fourth rotation motor for the plurality of second swing legs, wherein
the third rotation motor is configured to drive the plurality of first swing legs to rotate about the first hip rotation shaft; and
the fourth rotation motor is configured to drive the plurality of second swing legs to rotate about the second hip rotation shaft.

10. The mobile robot according to claim 1, wherein
rotation shafts of the at least three swing legs are located on a same vertical plane.

11. A method for controlling a mobile robot including at least three swing legs that are distributed side by side, the method comprising: controlling the at least three swing legs to execute a leg action on a reference plane.

12. The method according to claim 11, wherein a first swing leg group of the mobile robot includes a plurality of first swing legs, and at least two of the plurality of first swing legs are respectively located on two sides of a center of gravity of the mobile robot, wherein a second swing leg group of the mobile robot includes one second swing leg, and the one second swing leg is located on a central axis of the mobile robot, and wherein the controlling the at least three swing legs comprises:
controlling the first swing leg group and the second swing leg group to stand crosswise, the first swing leg group being located before the second swing leg group;
controlling, by using the first swing leg group as a first support leg, the second swing leg group to rotate to a first foot falling point; and
controlling, by using the second swing leg group as a second support leg, the first swing leg group to rotate to a second foot falling point.

13. The method according to claim 11, wherein a first swing leg group of the mobile robot includes one first swing leg that is located on a central axis of the mobile robot, wherein a second swing leg group of the mobile robot includes a plurality of second swing legs, and at least two of the plurality of second swing legs are respectively located on two sides of a center of gravity of the mobile robot, and wherein the controlling the at least three swing legs comprises:
controlling the first swing leg group and the second swing leg group to stand crosswise, the first swing leg group being located before the second swing leg group;
controlling, by using the first swing leg group as a first support leg, the second swing leg group to rotate to a first foot falling point; and
controlling, by using the second swing leg group as a second support leg, the first swing leg group to rotate to a second foot falling point.

14. The method according to claim 11, wherein a first swing leg group of the mobile robot includes a plurality of first swing legs, and at least two of the plurality of first swing legs are respectively located on two sides of a center of gravity of the mobile robot, wherein a second swing leg group of the mobile robot includes a plurality of second swing legs, and at least two of the plurality of second swing legs are respectively located on the two sides of the center of gravity of the mobile robot, and wherein the controlling the at least three swing legs comprises:
controlling the first swing leg group and the second swing leg group to stand crosswise, the first swing leg group being located before the second swing leg group;
controlling, by using the first swing leg group as a first support leg, the second swing leg group to rotate to a first foot falling point; and
controlling, by using the second swing leg group as a second support leg, the first swing leg group to rotate to a second foot falling point.

15. The method according to claim 14, wherein the controlling the second swing leg group to rotate to the first foot falling point comprises controlling, by using the first support leg, the second swing leg group to rotate about a second hip rotation shaft, until the second swing leg group rotates to the first foot falling point, and
wherein the controlling the first swing leg group to rotate to the second foot falling point comprises controlling, by using the second support leg, the first swing leg group to rotate about a first hip rotation shaft, until the first swing leg group rotates to the second foot falling point.

16. The method according to claim 15, wherein the controlling the second swing leg group to rotate about the second hip rotation shaft comprises:
determining to use the first support leg;
transmitting a second rotation instruction to a second rotation motor; and
controlling, based on the second rotation instruction, the second rotation motor to drive the second swing leg group to rotate about the second hip rotation shaft, until the second swing leg group rotates to the first foot falling point, and
wherein the controlling the first swing leg group to rotate about the first hip rotation shaft comprises:
determining to use the second support leg;
transmitting a first rotation instruction to a first rotation motor; and
controlling, based on the first rotation instruction, the first rotation motor to drive the first swing leg group to rotate about the first hip rotation shaft, until the first swing leg group rotates to the second foot falling point.

17. The method according to claim 15, wherein the controlling the second swing leg group to rotate about the second hip rotation shaft comprises:
using the first support leg;
transmitting a plurality of fourth rotation instructions to a plurality of fourth rotation motors respectively corresponding to the plurality of second swing legs; and
controlling, based on the plurality of fourth rotation instructions, the plurality of fourth rotation motors to drive the plurality of second swing legs to rotate about the second hip rotation shaft, until the plurality of second swing legs rotate to the first foot falling point, and
wherein the controlling the first swing leg group to rotate about the first hip rotation shaft comprises:
using the second support leg;
transmitting a plurality of third rotation instructions to a plurality of third rotation motors respectively corresponding to the plurality of first swing legs; and
controlling, based on the plurality of third rotation instructions, the plurality of third rotation motors to drive the plurality of first swing legs to rotate about the first hip rotation shaft, until the plurality of first swing legs rotate to the second foot falling point.

18. The method according to claim 17, wherein a first swing leg includes a first mechanical thigh connected to a first mechanical calf in a sleeved manner, wherein a second swing leg includes a second mechanical thigh connected to a second mechanical calf in a sleeved manner, and wherein the method further comprises:
controlling the first mechanical thigh and the first mechanical calf to extend and shorten along a first sleeved direction; and
controlling the second mechanical thigh and the second mechanical calf to extend and shorten along a second sleeved direction.

19. The method according to claim 18, wherein the mobile robot includes a first extension and shortening motor designed to implement linear transmission by using a lead screw nut, and wherein the method further comprises:
transmitting an instruction to the first extension and shortening motor, wherein the instruction includes at least one of: a linear movement position instruction, a linear movement speed instruction, or a driving force instruction; and
controlling the first extension and shortening motor, based on the instruction, to drive the first mechanical thigh and the first mechanical calf to extend and shorten along a sleeved direction.

20. A non-transitory computer-readable storage medium, storing computer code which, when executed by at least one processor, causes the at least one processor to at least:
control at least three swing legs of a mobile robot to execute a leg action on a reference plane, wherein the at least three swing legs are distributed side by side.
